(19) United States
(12) Patent Application Publication
(10) Pub. No.: US 2021/0238021 A1
(43) Pub. Date: Aug. 5, 2021

(54) AERIAL WORK VEHICLE AUXILIARY WIRELESS CONTROL DEVICE

(71) Applicant: Xtreme Manufacturing, LLC, Henderson, NV (US)

(72) Inventors: James Charles Masters, Henderson, NV (US); Andrew Jared Farnsworth, Henderson, NV (US); Jacob Wayne Adkins, Las Vegas, NV (US); Ryan Paul Sobotka, Eureka, MO (US)

(21) Appl. No.: 17/208,773

(22) Filed: Mar. 22, 2021

Related U.S. Application Data
(63) Continuation-in-part of application No. 16/781,298, filed on Feb. 4, 2020.

(51) Int. Cl. B66F 11/04; G08C 17/02

(52) U.S. Cl. CPC B66F 11/046; G08C 17/02

(57) ABSTRACT

An aerial work vehicle (AWV) includes a boom, and a work platform coupled to a distal end of the boom, where the work platform has a forward end in a direction of travel and an aft end opposite the forward end. The AWV also includes a first control device mechanically coupled to one of the forward end of the work platform or the aft end of the work platform and configured to control operation of at least the boom. In addition, the AWV includes an alternate, second, control device configured to control operation of at least the boom, which may be at least one of wireless and/or mechanically coupled to the work platform at a location different from a location of the first control device.

### CROSS-REFERENCE TO RELATED APPLICATION

This application is a continuation-in-part and claims the benefit of U.S. patent application Ser. No. 16/781,298, filed Feb. 4, 2020, entitled AERIAL WORK VEHICLE BOOM AUXILIARY CONTROL PANEL, which is incorporated by reference herein in its entirety.

### FIELD

The field of the disclosure relates generally to construction equipment, and more particularly self-propelled construction equipment including a boom and work platform positioned at a distal end of the boom.

### BACKGROUND

At least some known construction machines include a traveling table that includes a propulsion system configured to drive at least one wheel of the traveling table and a steerage system. The propulsion system and steerage system may be controlled from a first control console positioned on a work platform near the end of a boom coupled between the traveling bas and the work platform. Propulsion system and steerage system input devices located on the first control console permits operation of the propulsion system and steerage system from the first control console. The control console also includes input devices for controlling the boom. The boom is used to position work materials or a work platform close to a site of delivery of the work materials or a position for users to access a work site.

Typically, when operating the traveling table to get to a work site, an operator faces a first direction. The first control panel is oriented for operation with the operator facing in the first direction. However, when operating the boom, the operator faces the opposite direction to be able to observe the position of the boom or signals from a signaler during boom operations. During such times, the boom controls seem to the operator, to operate oppositely. For example, moving a joystick to the right moves the boom to the right when the operator is facing in the first direction. However, the boom operates backwards relative to the operator when faced in the second direction.

This Background section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION

In one aspect, an aerial work vehicle (AWV) is described. The AWV includes a boom, and a work platform coupled to a distal end of the boom, where the work platform has a forward end in a direction of travel and an aft end opposite the forward end. The AWV also includes a first control device mechanically coupled to one of the forward end of the work platform or the aft end of the work platform and configured to control operation of at least the boom. In addition, the AWV includes an alternate second control device configured to wirelessly control operation of at least the boom, wherein the second control device is one of: i) wireless, and ii) mechanically coupled to the work platform at a location different from a location of the first control device.

In another aspect, an auxiliary control device for controlling an AWV is described. The auxiliary control device includes an input device configured to receive one or more motion commands from an operator of the AWV, a transceiver, a processor, and a memory device storing computer-executable instructions, which when executed by the processor, cause the processor to at least: receive at least one motion command from the input device, in response to receiving the at least one motion command, control the transceiver to transmit a control signal to a control system of the AWV, where the control system of the AWV executes the at least one motion command based upon the control signal.

In yet another aspect, a method for controlling an AWV is described. The method includes providing an auxiliary control device, receiving, by a processor of the auxiliary control device and via an input device of the auxiliary control device, at least one motion command, and in response to receiving the at least one motion command, controlling, by the processor, a transceiver to transmit a control signal to a control system of the AWV, where the control system of the AWV executes the at least one motion command based upon the control signal.

### BRIEF DESCRIPTION OF THE DRAWINGS

FIG. 1 is a side elevation view of a type of construction machine, such as, an aerial work platform with a boom retracted.

FIG. 2 is a side elevation view of the construction machine with the boom extended.

FIG. 3 is a perspective view of a work platform that may be used with the construction machine shown in FIGS. 1 and 2.

FIG. 4 is a plan view of a control panel, which may be used in the position of a first control panel.

FIG. 5 is a perspective view of an auxiliary control panel.

FIG. 6 is a flowchart of a method of forming a construction machine.

FIG. 7 is a block diagram of an exemplary control system of the construction machine shown in FIGS. 1 and 2.

FIG. 8 is a perspective view of an exemplary wireless auxiliary control device, such as a wireless hand-held control device, for use with the construction machine shown in FIGS. 1 and 2.

FIG. 9 is a block diagram of an exemplary control system of the wireless auxiliary control device shown in FIG. 8.

FIG. 10 is a flowchart illustrating a process for wirelessly controlling the construction machine shown in FIGS. 1 and 2 using the wireless auxiliary control device shown in FIG. 8.

### DETAILED DESCRIPTION

A machinery control system that includes at least one ergonomically correctly oriented boom control panel and/or an auxiliary control device is described herein. Construction machinery, boats, and other vehicles may have more than one mode of operation including a self-propulsive mode of operation. Other modes of operation may be used when the self-propulsive mode is secured at a work site. The different modes of operation may also be associated with different directions of primary attention. In other words, during the self-propulsive mode of operation, the primary focus of the operator's attention is toward a forward end of the vehicle in the direction of travel. However, after arriving at a site of work activities, secured from the self-propulsive mode of operation and in another mode, for example, a boom operations mode, the primary focus of the operator's attention shifts to, in this example, the boom. Operating the boom with controls that are oriented for the operator facing in the direction of travel or the first direction is at best an inconvenience. The operator must remember that the controls are oriented for the operator to be facing in a direction opposite to the direction of his current primary focus, the boom. This requires the operator to make regular mental corrections for giving commands to the boom. For example, if the operator wants the boom to move to his current left when facing the boom, he must give a right direction input because the control console is oriented for forward facing operation and the boom is toward an aft end of the vehicle.

To alleviate this reverse orientation problem, systems and methods described herein incorporate one or more additional control panels and/or control devices, which may be oriented in the correct (or other desired) direction of operation in a mode other than the self-propulsive mode of operation, and when activated, may lock out the controls for the self-propulsive mode of operation. More particularly, in at least some embodiments, the systems and methods described herein incorporate a second control panel positioned substantially diametrically opposite a first control panel, where for example, the first control panel may be suitable for a self-propulsive mode of operation, while the second control panel may be oriented for use when the construction machine is operated in another mode. In addition, in at least some embodiments, an auxiliary control device, such as a hand-held wireless control device, may be provided. The auxiliary control device may facilitate remote operation of the construction machine from any suitable location and may be coupleable to and/or decoupleable from the construction machine as a substitute for, or addition to, the second control panel. In some embodiments, the auxiliary control device may also be provided in addition to the first and second control panels. As a result, the systems and methods described herein facilitate a variety of flexible options for providing control instructions to the construction machine, whatever the mode of operation, and whatever the location and orientation of the operator.

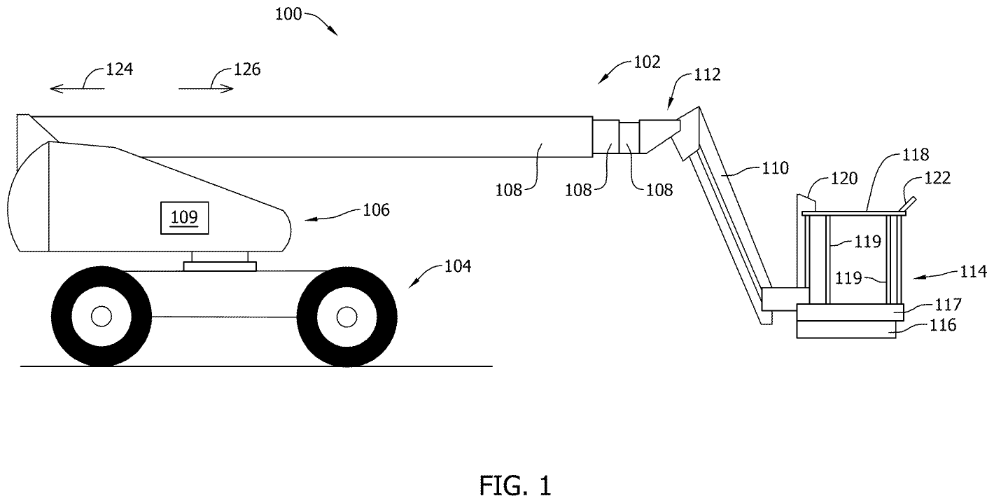

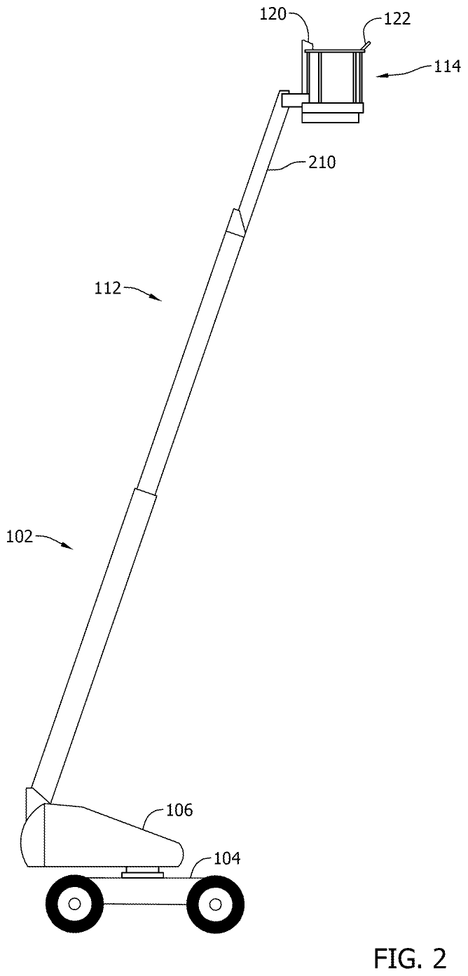

FIG. 1 is a side elevation view of a construction machine 100 of the aerial work platform type with a boom 102 retracted. As described herein, construction machine 100 may include any suitable aerial work vehicle (AWV), such as any boom lift, crane, telehandler, and the like. FIG. 2 is a side elevation view of construction machine 100 with boom 102 extended. In the example embodiment, construction machine 100 includes a chassis 104, a rotary table 106 and boom 102. Boom 102 is formed of one or more sections 108 that can be telescoped out to extend a height of boom 102. A high pressure fluid system 109 provides a motive force for operating boom 102. In various embodiments, high pressure fluid system 109 uses hydraulic oil fluid, however, other fluids may be used. A jib 110 coupled to a distal end 112 of one or more sections 108 facilitates leveling a work platform 114. Jib 110 also permits boom 102 to reach over, for example, obstacles, such as, walls and heating and ventilating equipment on a roof.

Work platform 114 includes a walking deck 116 for supporting a user and a kick plate 117. A handrail 118 provides fall protection for the user, and one or more stanchions 119 are provided that are usable for mounting equipment, such as, a first control panel 120 (or first control device) and a second control panel 122 (or second control device). As described herein, second control panel 122 may be implemented as an alternate, or auxiliary, control panel 122, which may be located at any suitable location on work platform 114, such as diametrically opposite first control panel 120, adjacent first control panel 120, and/or at any other suitable location on work platform 114. In addition, as described herein, an auxiliary, or alternate, control device 800, which may be wireless and/or hardwired, may also be included. In at least some embodiments, control device 800 may be implemented in addition to first and/or second control panels 120 and 122. Similarly, in at least some embodiments, control device 800 may be implemented as a replacement for first and/or second control panels 120 and/or 122. Accordingly, in at least some embodiments, first control panel 120 is oriented for observing indicia and operating control features on first control panel 120 by a user facing in a forward direction 124, which is typically the direction of travel around a jobsite., and second control panel 122 is oriented for observing indicia and operating control features by a user facing in a rearward direction 126 or in a direction other than the direction of travel. However, as described herein, other orientations and positions are also contemplated by and within the scope of the present disclosure.

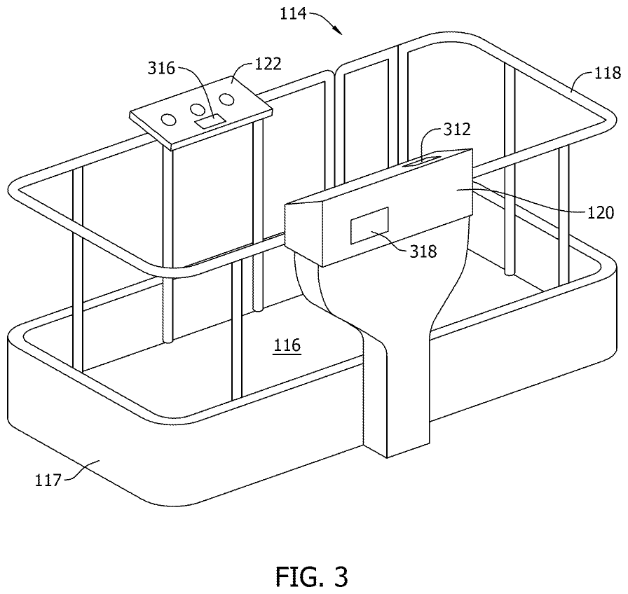

FIG. 3 is a perspective view of work platform 114 that may be used with construction machine 100. In the example embodiment, work platform 114 includes walking deck 116 and kick plate 117, and a handrail 118. Work platform 114 includes second control panel 122 including a second plurality of manual input devices 312 responsive to an operator for receiving manual boom motion commands for causing boom 102 to move in a desired direction and motion commands for causing chassis 104 to move in a desired direction. A second control panel 122 on work platform 114 includes a second plurality of manual input devices 316 responsive to an operator for providing boom motion commands for causing boom 102 to move in a desired direction. Work platform 114 also include a lockout circuit 318 interconnecting first control panel 120 and second control panel 122 to prevent motion commands received by first control panel 120 and second control panel 122 from causing chassis 104 to move when second control panel 122 is active.

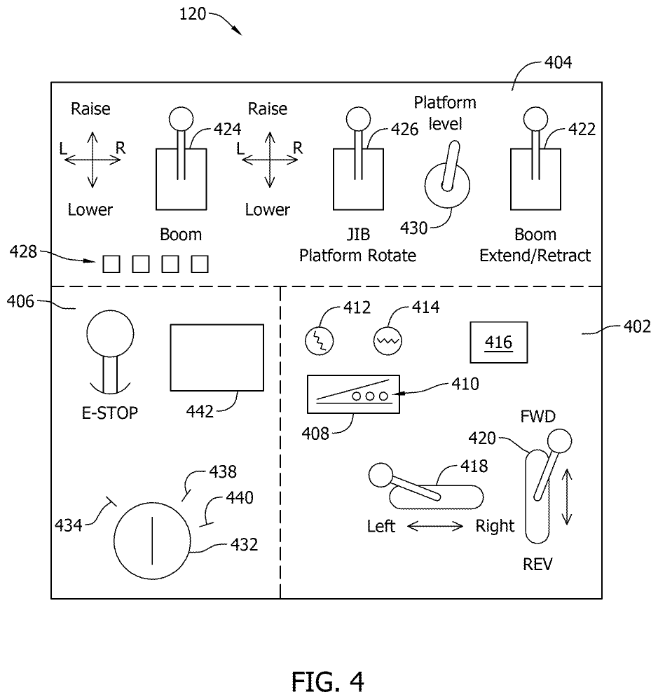

FIG. 4 is a plan view of first control panel 120. In the example embodiment, first control panel 120 includes a self-propulsion section 402, a boom section 404, and a lockout section 406.

Self-propulsion section 402 includes, for example, a battery condition indicator 408 having indicator LEDs 410 that light up to indicate the level of charge remaining in the batteries. For example, a lighted green LED indicates an adequate charge level. A lighted yellow LED indicates the need for charging soon. A lighted red LED warns that the battery charge level is low, boom operations should be halted until the batteries are recharged. Self-propulsion section 402 may also include an engine START switch or button 412 and, if necessary, a CHOKE control 414. A cold engine may be started by pressing Engine START button 412 while pressing and holding CHOKE control 414. To start/restart a warm engine, press START button 412 only. A display panel 416 is a lighted text window that displays the present operating status or an existing error condition. Display panel 416 may also include a plurality of soft keys or associated hard keys from which to accept input data. A steerage control 418 and propulsive speed control 420 are used to move construction machine 100 from one job site location to another. Steerage control 418 may be embodied in a joystick, as shown, or in a steering wheel, a trackball, or the like. Propulsive speed control 520 may be embodied as a joystick, as shown, or in a foot pedal or other control device.

Boom section 404 includes a boom extend/retract control 422, which is used to extend or retract the telescopic feature of boom 102. Boom motion continues until boom 102 extend/retract control 422 is released or until boom 102 reaches a hard stop or a safe travel limit. Operating a boom control 524 LOWER BOOM RAISE or the UPPER BOOM RAISE button or toggle will raise the selected boom segment. Pressing the LOWER BOOM DOWN or UPPER BOOM DOWN button will lower the selected boom segment. Boom 102 motion continues until boom control 424 is released or until each boom section 108 reaches a hard stop or a safe travel limit. Operating a JIB control 426 RAISE will raise a jib boom, if installed. Operating a JIB control 426 LOWER will lower the jib boom. Jib boom motion continues until the control is released or until the jib boom reaches a hard stop or a safe travel limit. Operating a BOOM ROTATION control 424 in a CW (clockwise) or a CCW (counterclockwise) commands table 106 to rotate in the direction selected until boom control 424 is released or a travel stop is reached. Boom 102 is capable of rotating through, for example, seven hundred degrees.

A plurality of SPEED buttons 428 may be available along the lower area of boom section 404. If available, one of plurality of SPEED buttons 428 may be selected prior to or simultaneous with selecting a boom function to command the speed at which the boom function should be carried out. In the example embodiment, four speeds are available to control the positioning of the boom lift.

A platform level switch 430 is actuated to level work platform 114. In one embodiment, platform level switch 430 levels work platform 114 only. In another embodiment, platform level switch 430 levels work platform 114 and, if necessary, controls for boom 102 and jib 110.

Lockout section 406 includes a key switch 432 used to select the active control panel for operating construction machine 100. Turning key switch 432 to a PLATFORM position 434 selects operation from first control panel 120. Turning key switch 432 to a PLATFORM (BOOM) position 438 selects operation from second control panel 122. A power off position 440 interrupts all electric and fluid power operations except emergency lowering. Removing the key protects against operation by unauthorized persons. The key may be removed with key switch 432 in any selected position.

Automatic outrigger extension/retraction may be accomplished using, for example, an outrigger control 442. In an embodiment, outrigger control 442 and a level control 444 may be activated simultaneously or sequentially to automatically deploy outriggers when needed. The outriggers may also be manually extended or retracted. An outrigger indicator notifies the operator when the outriggers are properly deployed and the weight of construction machine 100 is on the outriggers. Each of the outer outrigger indicators indicates load is on the outrigger footpad. Each of the inner outrigger indicators, when flashing, indicates that side is low and needs to be further raised for leveling.

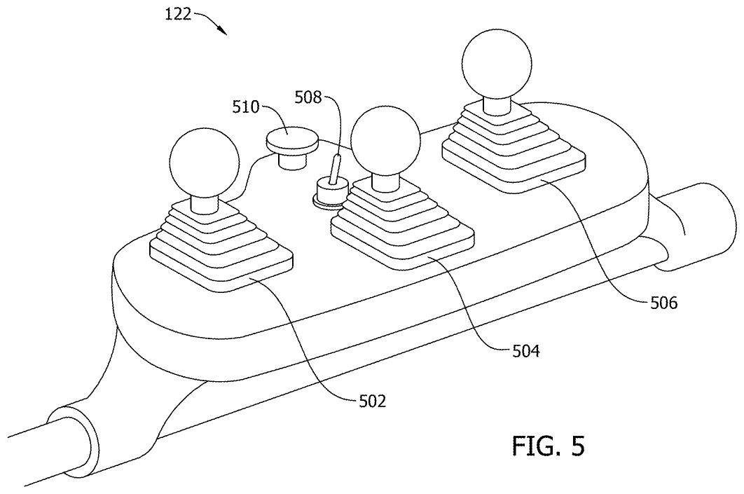

FIG. 5 is a perspective view of second control panel 122. In the example embodiment, second control panel 122 includes a boom joystick control 502, a jib/platform rotate joystick control 504, a boom extension joystick control 506, a platform level toggle control 508, and an emergency stop (E-stop) pushbutton 510.

In the example embodiment, second control panel 122 is oriented on work platform 114 facing in a direction opposite to the direction first control panel 120 is facing. Such an orientation permits an operator to view directly where work platform 114 is at all times with respect to obstacles without having to look over his shoulder as would be the case if the boom controls were only located on first control panel 120. Placement of second control panel 122 on the platform along with first control panel 120 permits an immediate and seamless transition from a vehicle propulsive mode to a boom operation mode.

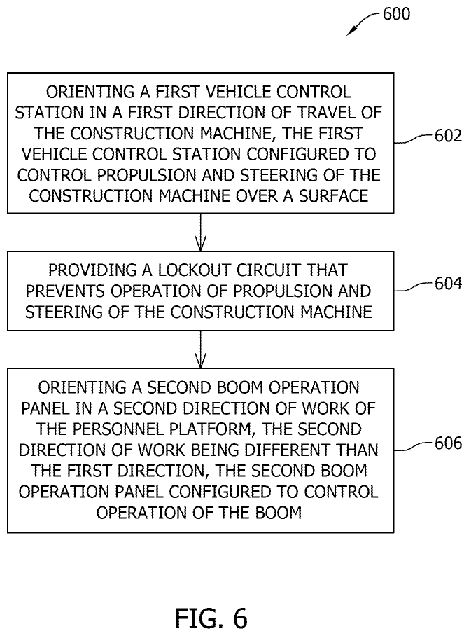

FIG. 6 is a flowchart of a method 600 of forming a construction machine. The construction machine includes a personnel platform coupled to a distal end of a boom. In the example embodiment, the method includes orienting 602 a first control panel in a first direction of travel of the construction machine. In other words, orienting the first control panel such that an operator facing the operator side of the first control panel is facing in the direction of travel, which is toward a forward end of the construction machine. The first control panel and the second control panel are oriented in opposite directions with respect to each other. Optionally, step 602 includes positioning the first control panel in the personnel platform mounted to at least one of a handrail and a stanchion. In various embodiments, the personnel platform includes a handrail surrounding a standing personnel platform deck. In other embodiments, the personnel platform includes a stanchion coupled to the deck standing upright. The stanchion may also be tilted, or canted and may be supported by the handrail, or only partially supported by the handrail. The first control panel is configured to control propulsion and steering of the construction machine over a surface.

Method 600 also includes providing 604 a lockout circuit that prevents operation of propulsion and steering of the construction machine during operation of the boom and may prevent operation of the boom during operation of the propulsion and steering of the construction machine. In some embodiments, operation of the propulsion and steering of the construction machine is permitted while the boom is being operated, for example, when operating the boom for personnel platform leveling, lowering the boom, or putting the boom in a condition better suited for the operating envelope being used. The lockout circuit provides an interlock that prevents operation of the boom during operation of propulsion and steering of the construction machine and prevents operation of propulsion and steering of the construction machine during operation of the boom.

Method 600 further includes orienting 606 a second control panel in a second direction of work of the personnel platform. The second direction being different than the first direction. The second control panel is configured to control operation of the boom. Optionally, step 606 includes positioning the first control panel and the second control panel in the personnel platform mounted to the handrail or a stanchion. In various embodiments, the personnel platform includes a handrail surrounding the standing personnel platform deck. In other embodiments, the personnel platform includes a stanchion coupled to the deck standing upright. The stanchion may also be tilted, or canted and may be supported by the handrail, or only partially supported by the handrail.

In the example embodiment, the first control panel and the second control panel are oriented face-to-face across a gap where an operator would stand while driving the construction machine or while operating the boom. Face-to-face refers to the position of the first control panel and the second control panel relative to each other.

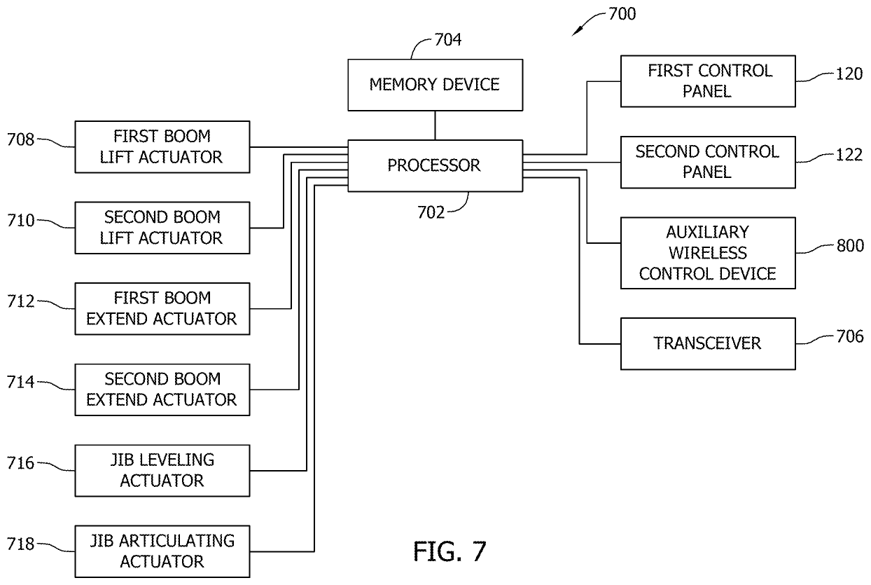

FIG. 7 is a block diagram of an exemplary control system 700 that may be used with construction machine 100 (shown in FIGS. 1 and 2). In the exemplary embodiment, control system 700 includes a processor 702 communicatively coupled to a memory device 704 that stores instructions, which when executed by processor 702 cause processor 702 to perform the various processes and actions described herein. In some embodiments, memory device 704 may be physically separate from processor 702. Alternatively or additionally, memory device 704 may be included on processor 702, such as, for example, as part of an integrated circuit of processor 702.

In at least some embodiments, memory device 704 may include one or more devices that enable information, such as executable instructions and/or other data, to be stored and retrieved. Moreover, the memory device 704 may include one or more computer readable media, such as, without limitation, dynamic random access memory (DRAM), static random access memory (SRAM), a solid state disk, and/or a hard disk. As described herein, in the exemplary embodiment, memory device 704 may store, without limitation, application source code, application object code, configuration data, additional input events, application states, assertion statements, validation results, and/or any other type of data. Control system 700 may, in some embodiments, also include a communication interface that is coupled to the processor 702 via a system bus, which may also interconnect memory device 704, any of a variety of peripheral devices, such as sensors and/or actuators, and the like.

In the exemplary embodiment, processor 702 may also be communicatively coupled to one or more transceivers 706, which may be configured to establish wireless communication with a wireless auxiliary wireless control device 800 as described herein. In some embodiments, transceiver 706 may thus include a radio frequency (RF) transceiver for sending and/or receiving wireless signals. Likewise, in some embodiments, transceiver 706 may include any suitable near field communication (NFC) device. Moreover, in at least some embodiments, transceiver 706 may implement any other suitable wireless communication protocol, such as any WiFi, BLUETOOTH, and/or narrow band internet of things (IOT) protocol, as well as any cellular communication protocol. For example, in at least one embodiment, transceiver 906 may be configured to operate as a narrow band IOT transceiver in a range of approximately 30 GHz to 100 GHz.

Moreover, in the exemplary embodiment, processor 702 may be coupled to and/or configured to control portions of high pressure fluid system 109, such as any of a variety of actuators 708-718, that provide motive forces for selectively raising, lowering, extending, and retracting, as the case may be, boom 102 and/or jib 110. For example, in at least some embodiments, processor 702 may control at least a first boom lift actuator 708, a second boom lift actuator 710, a first boom extend actuator 712, a second boom extend actuator 714, a jib leveling actuator 716, and/or a jib articulating actuator 718. In at least some embodiments, actuators 708-718 are hydraulic actuators, such as fluid operated cylinder and piston assemblies. In general terms, a flow of hydraulic fluid may be provided to, and/or released from, actuators 708-718 to cause selective extension of actuators 708-718 and/or retraction of actuators 708-718. Further, to control a flow of hydraulic fluid to actuators 708-718, processor 702 may, in various embodiments, provide control signals to one or more hydraulic pumps, hydraulic valves, and the like fluidly coupled to actuators 708-718 to selectively control the flow of hydraulic fluid to actuators 708-718.

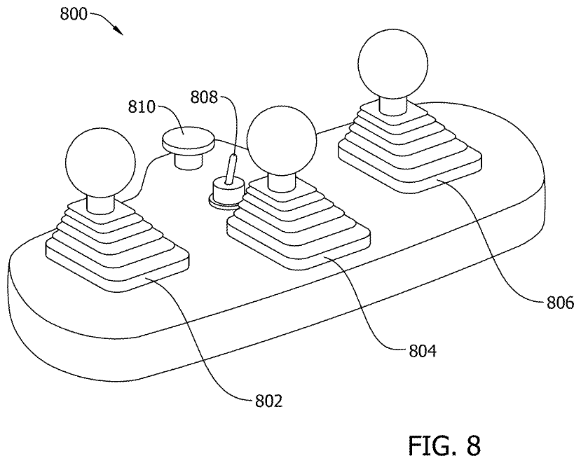

FIG. 8 is a perspective view of an exemplary auxiliary, or alternate, control device 800, such as a wireless (and/or wired) hand-held control device, that may be used with construction machine 100 (shown in FIGS. 1 and 2). As described herein, in some cases, construction machine 100 may include first control panel 120 as well as second control panel 122. Further, as described herein, first control panel 120 may be coupled to work platform 114 in a forward-facing 124 orientation. Similarly in operation, second control panel 122 may be coupled to work platform 114 in a diametrically-opposite, rear-facing 126 direction, as well as at any other location, position, direction, and/or orientation. For example, in at least some embodiments, auxiliary control device 800 may be coupled to work platform 114 at any location, such as adjacent to either of first control panel 120 and/or second control panel 122, and/or at any other suitable location, as desired. In addition, in at least some embodiments, auxiliary control device 800 may, as described herein, be removably coupleable to construction machine 100 (e.g., including work platform 114) at any suitable or desired location. Moreover, as described herein auxiliary control device 800 may be hand-held, such that auxiliary control device 800 can be operated in a wireless mode without any physical connection to construction machine 100 (e.g., an operator may roam or move about construction machine 100 with auxiliary control device 800).

In addition to these features, in at least some embodiments, auxiliary control device 800 may include be included in addition to first and/or second control panel 120, and/or as an alternative to one or other of control panels 120 and/or 122. Moreover, similar to first control panel 120 and second control panel 122, auxiliary control device 800 may also control construction machine 100, as described herein. Specifically, auxiliary control device 800 may also control boom 102, jib 110, and the like. Moreover, in some embodiments, auxiliary control device 800 may perform any and/or all of the control operations that first control panel 120 and/or second control panel 122 perform, as described above. However, in other embodiments, auxiliary control device 800 may be perform a portion of the control functionality provided by first control panel 120 and/or second control panel 122.

In the exemplary embodiment, although first control panel 120 and/or 122 may be hardwired to control system 700, auxiliary control device 800 may wirelessly communicate with control system 700 to provide control instructions to construction machine 100. However, as described herein, in at least some embodiments, auxiliary control device 800 may communicate with control system 700 via a suitable wired connection. In addition, auxiliary control device 800 may advantageously include any suitable hand-held device and/or hand-held geometry, such that auxiliary control device 800 need not be physically coupled to construction machine 100. Rather, in the exemplary embodiment, an operator of construction machine 100 may provide control instructions using wireless auxiliary control device 800 from any remote location, and without being constrained by any physical coupling or physical connection between auxiliary control device 800 and construction machine 100.

In one embodiment, the operator may hold auxiliary control device 800 in one or both hands at a ground location to control boom 102 and/or jib 110. Likewise, the operator may carry auxiliary control device 800 into work platform 114 to control boom 102 and/or jib 110 as well, depending in general upon the operating preferences and location of the operator. In wireless implementations, the wireless range of auxiliary control device 800 may be any suitable wireless range, such as a range of less than a meter to a range of greater than one-hundred meters.

In various embodiments, auxiliary control device 800 may be of any suitable shape and/or size. For example, the geometry of auxiliary control device 800 may be adjusted or tailored as desired to accommodate single-handled operation, two-handed operation, and the like. The geometry depicted at FIG. 8 is thus merely illustrative. It will be appreciated that a variety of other shapes and geometries, many ergonomic, are contemplated.

Further, in the exemplary embodiment, auxiliary control device 800 may include the same functionality as second control panel 122, such that auxiliary control device 800 may, in at least some implementations, be included with construction machine 100 as a wireless or otherwise mobile version of, and thus a possible replacement for, second control panel 122. Accordingly, in at least some embodiments, auxiliary control device 800 may include a boom joystick control 802, a jib/platform rotate joystick control 804, a boom extension joystick control 806, a platform level toggle control 808, and/or an emergency stop (E-stop) pushbutton 810.

However, in other embodiments, auxiliary control device 800 may include a subset of elements 802-810 as well as, in some cases, one or more additional devices, control instruments, and/or the like. For example, in at least some embodiments, auxiliary control device 800 may include a touchscreen display device, such as a capacitive touchscreen display. Touchscreen displays are generally known and are not described further herein. In some implementations, a touchscreen display device may be substituted for any of elements 802-810, and/or in at least some embodiments, a touchscreen display may be provided in addition to elements 802-810. Similarly, in at least one implementation, auxiliary control device 800 may include a smartphone or tablet computing device, which may be provided in addition to elements 802-810 and/or in lieu of elements 802-810. Accordingly, auxiliary control device 800 may in various embodiments be implemented entirely and/or partially in the form of a smartphone, a tablet computing device, and/or any other wireless computing device that includes a touchscreen display and/or a touchscreen graphical user interface for controlling operation of construction machine 100, as described herein.

Moreover, although auxiliary control device 800 may, in at least some implementations, not require any sort of mechanical coupling to construction machine 100 during operation, in one or more additional or alternative implementations, auxiliary control device 800 may also mechanically couple to, or “dock with,” construction machine 100. For example, in at least some embodiments, work platform 114 may include one or more brackets and/or another suitable mounting structure oriented to dock or otherwise secure auxiliary control device 800 to work platform 114. In some embodiments, the mounting structure may be provided in the same position that control panel 122 occupies. Moreover, in some embodiments, when auxiliary control device 800 is docked with or otherwise mechanically coupled to work platform, auxiliary control device 800 may also connect to and communicate with control system 700 via any suitable wired connection, such as an Ethernet connection, an RS-232 connection, and/or, it will be appreciated, any other suitable wired electronic connection.

For example, as described herein, because wireless auxiliary control device 800 may include the same or a subset of the functionality of control panel 122, auxiliary control device 800 may also, in at least some embodiments, be included as a replacement for, or an alternative to, control panel 122, which may be a more permanent version of auxiliary control device 800. In such embodiments, auxiliary control device 800 may be positioned approximately 180° from first control panel 120 and/or at any other suitable location, position, and/or orientation on work platform 114. Further, auxiliary control device 800 may be selectively coupled to and/or decoupled from work platform, such as using the mounting structure or docking station, which may facilitate attachment and detachment of auxiliary control device 800 from work platform 114, as desired. Further, when auxiliary control device 800 is coupled to or docked with work platform, auxiliary control device 800 may operate, as described herein, in either a wireless mode and/or in a wired, or docked, mode.

In some embodiments, both control panels 120 and 122 may be used in combination with auxiliary control device 800. In such embodiments, auxiliary control device 800 may be operated as desired, such as in a wireless mode within a predesignated wireless range (e.g., several hundred meters or less, for example), and/or in a wired mode, where for example, work platform 114 may include one or more mounting structures at any suitable location for temporarily docking auxiliary control device 800. As a result, it can be seen that auxiliary control device 800 may be operated in several modes, including wired and/or wireless modes, and that auxiliary control device 800 may be removably coupled to any suitable position on construction machine 100, including, but not limited to being on work platform 114 and/or elsewhere (e.g., in a lower cab) on construction machine 100.

In addition, as described in additional detail herein, and in at least some embodiments, first control panel 120 and/or second control panel 122 may include a lockout circuit 318 that may be selectively enabled or activated to lock any unused auxiliary control device 800 or control panel 120 and/or 122 that is not operating to prevent unintentional operation of construction machine 100. Further, although control panel 120 includes lockout circuit 318 in the exemplary embodiment, it will be appreciated that any and/or each of control panel 120, control panel 122, and/or auxiliary control device 800 may include a respective lockout circuit, such as for increased safety, added convenience, and/or the like.

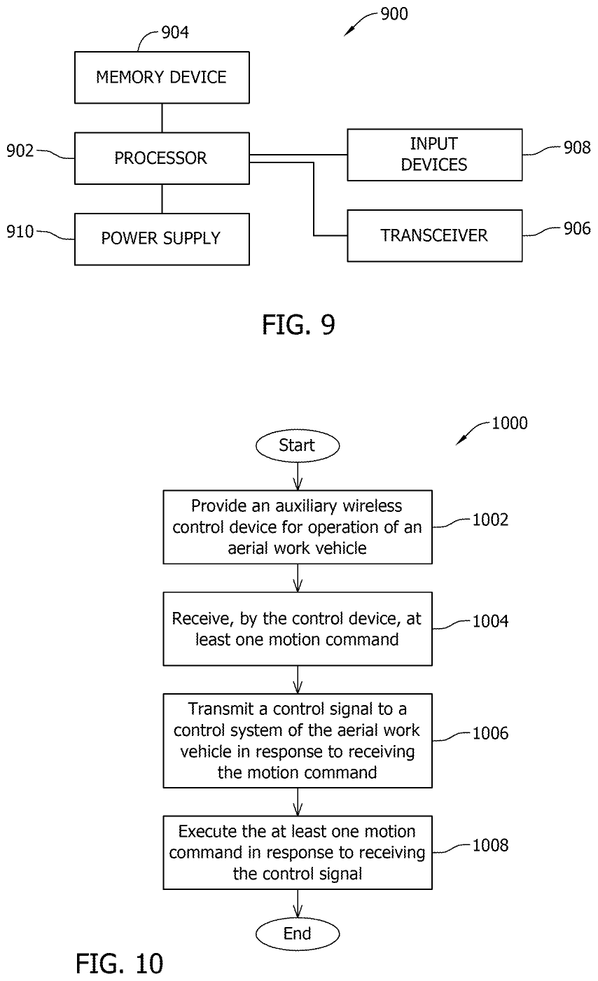

FIG. 9 is a block diagram of an exemplary control system 900 of auxiliary control device 800 (shown in FIG. 8). Accordingly, as shown, control system 900 includes a processor 902 communicatively coupled to a memory device 904 that stores instructions which when executed by processor 902 are configured to cause processor 902 to perform the various processes and actions described herein. In some embodiments, memory device 904 may be physically separate from processor 902. Alternatively or additionally, memory device 904 may be included on processor 902, such as, for example, as part of an integrated circuit of processor 902.

In at least some embodiments, memory device 904 may include one or more devices that enable information, such as executable instructions and/or other data, to be stored and retrieved. Moreover, the memory device 904 may include one or more computer readable media, such as, without limitation, dynamic random access memory (DRAM), static random access memory (SRAM), a solid state disk, and/or a hard disk. As described herein, in the exemplary embodiment, memory device 904 may store, without limitation, application source code, application object code, configuration data, additional input events, application states, assertion statements, validation results, and/or any other type of data. Control system 900 may, in some embodiments, also include a communication interface that is coupled to the processor 902 via a system bus, which may also interconnect memory device 904, any of a variety of peripheral devices, such as sensors and/or actuators, and the like.

In the exemplary embodiment, processor 902 may also be communicatively coupled to one or more transceivers 906, which may be configured to establish wireless communication with transceiver 706 of control system 700, as described herein. In some embodiments, transceiver 906 may thus include a radio frequency (RF) transceiver for sending and/or receiving wireless signals. Likewise, in some embodiments, transceiver 906 may include any suitable near-field communication device (NFC device). Moreover, in at least some embodiments, transceiver 906 may implement any other suitable wireless communication protocol, such as any WiFi, BLUETOOTH, and/or narrow band internet of things (IOT) protocol, as well as any 2G, 3G, 4G, and/or 5G communication protocol. For example, in at least one embodiment, transceiver 906 may be configured to operate as a narrow band IOT transceiver in a range of approximately 30 GHz to 100 GHz.

Moreover, in the exemplary embodiment, control system 900 may include one or more input devices 908, communicatively coupled to processor 902, such as any of the input devices 802-810 described herein (as shown with reference to FIG. 8). Further, in at least some embodiments, input devices 908 may include any suitable display device, such as any touchscreen display device, which may provide one or more graphical user interfaces (GUIs) that facilitate control of boom 102, jib 110, actuators 708-718, and/or other physical components of construction machine 100.

In the exemplary embodiment, control system 900 may also include a power supply 910, such as a rechargeable battery, a primary (or non-rechargeable) battery, and/or any other suitable power supply. In at least some embodiments, power supply 910 may be recharged by connecting auxiliary control device 800 to a charging port (e.g., via a charging cable) of construction machine 100. Likewise, it will be appreciated that power supply 910 may be variously charged, such as by any suitable universal serial bus (USB) charging connection coupled to a power source, such as a wall outlet and/or another power source. In some embodiments, power supply 910 may also be arranged to receive a wireless charge, such as by placing auxiliary control device 800 near an inductive charging device.

FIG. 10 is a flowchart illustrating a process 1000 for wirelessly controlling an AWV, such as construction machine 100. Accordingly, in the exemplary embodiment, and as described in additional detail above, process 1000 may include providing auxiliary wireless control device 800, such as with a kit and/or otherwise together with and/or as an additional component of construction machine 100 (step 1002). In addition, process 1000 may include receiving, by processor 902 of auxiliary control device 800 and via at least one input device 908 of auxiliary control device 800, at least one motion command (step 1004). Further, in the example embodiment, process 1000 may include controlling, by processor 902, transceiver 906 to transmit a control signal to control system 700 of construction machine 100, such as in response to receiving the at least one motion command (step 1006). In response to receiving the control signal, processor 702 of control system 700 may, in addition, execute the at least one motion command based upon the control signal (step 1008).

The systems and methods described herein thus incorporate one or more additional control panels and/or control devices, which may be selectively oriented in the direction of operation in a mode other than the self-propulsive mode of operation, When activated, in the exemplary embodiment, the additional control panel and/or control devices may be used to selectively lock out the controls for the self-propulsive mode of operation. More particularly, in at least some embodiments, the systems and methods described herein incorporate a second control panel positioned substantially diametrically opposite a first control panel, where for example, the first control panel may be suitable for a self-propulsive mode of operation, while the second control panel may be oriented for use when the construction machine is operated in another mode. In addition, in at least some embodiments, an auxiliary control device, such as a hand-held wireless control device, may be provided. The auxiliary control device may facilitate remote operation of the construction machine from any suitable location and may be coupleable to and/or decoupleable from the construction machine as a substitute for the second control panel. In some embodiments, the auxiliary control device may also be provided in addition to the first and second control panels. As a result, the systems and methods described herein facilitate a variety of flexible options for providing control instructions to the construction machine, whatever the mode of operation, and whatever the location and orientation of the operator.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An aerial work vehicle (AWV) comprising:
a boom;
a work platform coupled to a distal end of the boom, the work platform having a forward end in a direction of travel and an aft end opposite the forward end;
a first control device mechanically coupled to one of the forward end and the aft end of the work platform to control operation of at least the boom; and
an alternate second control device configured to control operation of at least the boom, wherein the second control device is one of: i) wireless, and ii) mechanically coupled to the work platform at a location different from a location of the first control device.

2. The AWV of claim 1, wherein the first control device includes a lockout circuit interconnecting the first control device and the second control device to prevent motion commands received by one of the first control device or the second control device from causing the boom to move when the other of the first control device or the second control device is active.

3. The AWV of claim 1, wherein the first control device is permanently coupled to the one of the forward end of the work platform or the aft end of the work platform, and wherein the second control device is one of i) mechanically separate from the work platform and ii) removably coupleable to the work platform.

4. The AWV of claim 1, wherein the second control device is an auxiliary wireless hand-held device that includes a rechargeable power supply.

5. The AWV of claim 4, wherein the rechargeable power supply is configured to be coupled to electrical power provided by the AWV to recharge the rechargeable power supply.

6. The AWV of claim 1, wherein the second control device comprises:
an input device configured to receive one or more motion commands from an operator of the AWV;
a wireless transceiver;
a processor; and
a memory device storing computer-executable instructions, which when executed by the processor, cause the processor to at least:
receive at least one motion command from the input device; and
in response to receiving the at least one motion command, control the wireless transceiver to transmit a control signal to a control system of the AWV, wherein the control system of the AWV executes the at least one motion command based upon the control signal.

7. The AWV of claim 6, wherein the wireless transceiver is one of a radio frequency (RF) transceiver, a Bluetooth transceiver, and a WiFi transceiver.

8. The AWV of claim 1, further comprising:
a control system comprising:
a wireless transceiver;
a processor; and
memory device storing computer-executable instructions, which when executed by the processor, cause the processor to at least:
control the wireless transceiver to receive a control signal from the hand-held control device, the control signal including at least one motion command; and
execute the at least one motion command to control an operation of the AWV.

9. The AWV of claim 8, wherein the wireless transceiver is one of a radio frequency (RF) transceiver, a Bluetooth transceiver, and a WiFi transceiver.

10. The AWV of claim 1, wherein the second control device comprises at least one of: i) a first input device for controlling a level of the boom; ii) a second input device for controlling an extension position of the boom, or iii) a third input device for controlling a motion of a jib coupled to and extending relative to the boom.

11. An auxiliary control device for controlling an aerial work vehicle (AWV), the auxiliary control device comprising:
an input device configured to receive one or more motion commands from an operator of the AWV;
a transceiver;
a processor; and
a memory device storing computer-executable instructions, which when executed by the processor, cause the processor to at least:
receive at least one motion command from the input device; and
in response to receiving the at least one motion command, control the transceiver to transmit a control signal to a control system of the AWV, wherein the control system of the AWV executes the at least one motion command based upon the control signal.

12. The auxiliary control device of claim 11, wherein the transceiver is one of a radio frequency (RF) transceiver, a Bluetooth transceiver, and a WiFi transceiver.

13. The auxiliary control device of claim 11, wherein the auxiliary control device is one of i) mechanically separate from a work platform of the AWV, and ii) removably coupleable to the work platform, and wherein the work platform is coupled to a boom of the AWV.

14. The auxiliary control device of claim 11, wherein the auxiliary control device is configured to engage with the work platform of the AWV, whereby the auxiliary control device is couplable to and decoupleable from the work platform.

15. The auxiliary control device of claim 11, wherein the auxiliary control device is configured to be removably coupled to a work platform of the AWV in a position diametrically opposite a fixed control panel of the work platform.

16. The auxiliary control device of claim 11, wherein the auxiliary control device includes a rechargeable power supply.

17. The auxiliary control device of claim 16, wherein the auxiliary control device is configured to receive electrical power from the AWV to recharge the rechargeable power supply.

18. The auxiliary control device of claim 11, wherein the auxiliary control device is one of: i) wireless, and ii) mechanically coupled to the work platform at a location different from a location of a first control panel also coupled to the work platform, and wherein the auxiliary control device is configured to operate as an alternate to the first control panel.

19. The auxiliary control device of claim 11, wherein a range of the transceiver is at least two-hundred feet, such that the auxiliary control device is enabled to provide the control signal to the control system of the AWV from a position on the ground.

20. A method for controlling an aerial work vehicle (AWV), the method comprising:
providing a first control device;
providing an alternate second control device in addition to the first control device;
receiving, by a processor of the second control device and via an input device of the second control device, at least one motion command; and
in response to receiving the at least one motion command, controlling, by the processor, a transceiver to transmit a control signal to a control system of the AWV, wherein the control system of the AWV executes the at least one motion command based upon the control signal.
